(19) United States
(12) Patent Application Publication
(10) Pub. No.: US 2015/0027417 A1
(43) Pub. Date: Jan. 29, 2015

(54) Filter Head for an Exchange or Housing Filter

(71) Applicant: MANN+HUMMEL GMBH, Ludwigsburg (DE)

(72) Inventors: Christian Kocksch, Roemerberg (DE); Christopher Banks, Leimen (DE); Martin Postel, Hassloch (DE); Ahmet Oerther, Weilburg (DE)

(21) Appl. No.: 14/444,825

(22) Filed: Jul. 28, 2014

(30) Foreign Application Priority Data
Jul. 29, 2013 (DE) 10 2013 012 440.9

(51) Int. Cl. F02M 37/22; F02M 37/08

(52) U.S. Cl. CPC F02M 37/22; F02M 37/08; F02M 2037/225
USPC 123/497

(57) ABSTRACT

A filter head for a pre-filtration filter for fuel has an electric pump received in a pump channel. A connecting channel connects the pump at a suction side with a clean side of the filter. An outlet channel connects the pump at a pressure side with a main filter for the pre-filtered fuel. The pump is alternatingly operated in at least two of the following operating modes: a feed or follow-up operation in which, before switching on or after switching off an ignition of the internal combustion engine, the pump supplies fuel to the outlet channel; a venting operation in which the pump pumps air out of the filter and/or a fuel line of the filter head; and a support operation in which, with switched-on ignition, the pump supplies fuel at a pressure suitable as input pressure for a high-pressure pump arranged downstream of the main filter.

### CROSS-REFERENCE TO RELATED APPLICATION

This application claims the benefit of German patent application No. 10 2013 012 440.9, filed Jul. 29, 2013, the entire contents of the aforesaid German patent application being incorporated herein by reference

### BACKGROUND OF THE INVENTION

The present invention concerns a filter head for an exchange or housing filter for pre-filtration of fuel for an internal combustion engine, a filter arrangement, a fuel system, as well as a method.

For example, DE 199 17 349 A1 discloses a filter head for an exchange filter. The filter head has an integral pump that is suitable for pressurizing a fuel supply line and for removing air pockets in the fuel supply line. Here, the filter head with the exchange filter is arranged downstream of a fuel tank. Downstream, a main filter is provided and downstream thereof an injection device.

### SUMMARY OF THE INVENTION

It is an object of the present invention to provide an improved filter head for an exchange or housing filter.

Accordingly, a filter head for an exchange or housing filter for filtration of fuel for an internal combustion engine comprising a pump channel, an electrically operated pump, a connecting channel, and an outlet channel is provided. The pump is at least partially received in the pump channel. The connecting channel is adapted to connect the pump at the suction side with a clean side of the exchange or housing filter. The outlet channel is adapted to connect the pump at the pressure side with a main filter for filtration of the pre-filtered fuel. The pump is adapted to be alternatingly operated in at least two of the following operating modes: a feed or follow-up operation in which, before switching on or after switching off an ignition of the internal combustion engine, it provides fuel at the outlet; a venting operation in which it pumps air out off the exchange or housing filter and/or out of a fuel line connected with the filter head; and a support operation in which, with the ignition of the internal combustion engine switched on, it supplies the fuel at a pressure that is suitable as an input pressure for a high-pressure pump downstream of the main filter.

The idea upon which the present invention is based resides in that the filter head or the pump are provided with several operating modes. As described above, these are a feed or follow-up operation, a venting operation, and a support operation. The pump is adapted to alternatingly operate in at least two of these operating modes. However, the pump could also be adapted to be alternatingly operated in all three operating modes. At a defined point in time, the pump can however be operated in only one of the aforementioned operating modes. Thus, the pump can have, for example, a feed or follow-up operation as well as a venting operation. Alternatively, the pump can have a feed or follow-up operation and a support operation. Further, alternatively, the pump can have a venting operation and a support operation. Finally, the pump can have a feed or follow-up operation, a venting operation, and a support operation. The selection of the respective operating mode can be realized by means of a control device which accordingly controls the pump in the feed or follow-up operation, the venting operation, or the support operation.

Since the pump can be operated in at least two different operating modes, a high flexibility results for using the filter head. The latter can be operated, as a function of the fuel system in which it is used, with a suitable operating mode without having to carry out constructive changes.

The exchange filter can be in particular a spin-on filter. The exchangeable filter thus has a thread which can be screwed onto an appropriate counter thread on the filter head. When the filter medium of the exchange filter has reached the end of its service life, the exchange filter as a whole is exchanged.

The housing filter comprises in particular a cup-shaped housing and a filter element which is exchangeably received therein. The housing filter is, for example, detachably screwable onto the filter head. When the filter medium of the filter housing filter has reached the end of its service life, only the filter element is exchanged.

As a fuel, in particular diesel fuel or kerosene are conceivable. However, the use of the filter head for gasoline or oil is not excluded.

Preferably, the exchange or housing filter is used as a pre-filter. For example, the exchange or housing filter, as a pre-filter, can separate particles with a size of, for example, >10 μm and/or water contained in the fuel.

The electrically operated pump comprises preferably a brushless direct current motor. The latter can be controlled flexibly and therefore realize in a simple way the various operating modes of the pump. Also, a pump wheel which is operated by the direct current motor for conveying the fuel is suitably designed for the respectively provided operating modes.

The pump channel, the inlet channel, and the outlet channel can be embodied in a one-part housing.

In embodiments, the outlet channel can be configured to connect the pump at the pressure side directly with an injection device, without intermediate positioning of a main filter or a high-pressure pump.

In the feed or follow-up operation, the fuel that is provided at the outlet channel can be used for cooling components of the internal combustion engine and/or of the injection device.

In the venting operation, in particular air or air pockets contained in the exchange or housing filter are removed. Such air pockets result regularly after an exchange of the exchange filter or of the filter element of the housing filter. In general, air can be removed from the fuel system by means of the venting operation.

In the support operation, it is possible to eliminate a presupply pump because the pump supplies the fuel at a pressure which is suitable as an input pressure for the high-pressure pump. This can contribute to simplifying assembly as well as to lowering costs. In the support operation, the pump continuously supplies fuel to the high-pressure pump.

The ignition being switched on means that a combustion process is taking place in the internal combustion engine for which purpose fuel is supplied by means of the filter head or the fuel system to an injection device of the internal combustion engine.

According to an embodiment, a first bypass valve is provided which connects the pump at the pressure side with a raw or clean side of the exchange or housing filter when the pressure at the pressure side of the pump surpasses a predetermined pressure.

When, for example, the main filter is clogged or a valve in the injection device is closed accidentally, there is the risk that the pump will be destroyed as a result of current strengths that are too high. The first bypass valve remedies this in that it returns the pre-filtered fuel downstream of the pump to the raw side of the exchange or housing filter. This takes place when the pressure at the pressure side of the pump surpasses a predetermined pressure. This pressure can be, for example, between 2.5 bar and 7.5 bar, preferably between 4.5 bar and 5.5 bar.

According to an embodiment, the first bypass valve is a check valve biased by a spring. Such a check valve can be produced easily.

According to a further embodiment, a second bypass valve is provided which connects the clean side of the exchange or housing filter with the outlet channel when, with the pump switched off, the pressure in the outlet drops below a predetermined pressure.

When the ignition of the internal combustion engine is switched on and the pump is switched off, a pre-supply and/or high-pressure pump arranged downstream of the filter head or the main filter can suck in the fuel directly out of the exchange or housing filter. The second bypass valve can be provided without the first bypass valve being provided.

According to an embodiment, the second bypass valve is a gravity-loaded check valve. The gravity-loaded check valve can have, for example, a valve member which, in the closed state of the check valve, seals relative to a valve seat wherein the sealing forces are generated by the gravity acting on the valve member. In the open position of the check valve, the fuel forces the valve member from below in upward direction and can thus flow between valve seat and valve member into the outlet channel. A gravity-loaded check valve is particularly inexpensive with regard to manufacture.

According to a further embodiment, the second bypass valve has a spherical valve member. The latter is associated advantageously with only minimal pressure loss.

According to a further embodiment, the pump is connectable in the pump channel alternatingly to one or the other of the ends of the pump channel.

In other words, the pump, for example, as a function of the spatial conditions, can be installed from different ends into the pump channel. This facilitates in particular supply of current to the pump.

According to a further embodiment, a heating element is receivable at least partially in an inlet channel of the filter head and is alternatingly connectable to one or the other of the ends of the inlet channel.

The heating element can be configured, for example, as a heating rod. Since the heating element can be installed from different ends into the inlet channel, for example, as a function of the spatial conditions, a current supply to the heating element can be guided beneficially.

According to an embodiment, the pump channel, the inlet channel, and/or the outlet channel are arranged parallel to each other.

A housing provided with the channels can be, for example, produced of metal, in particular by a diecasting method, and/or of plastic material, in particular by an injection molding process. The channels can be formed each within a tubular body. Closure elements can close off an end of a corresponding channel, respectively.

According to a further embodiment, a connecting socket, with which the clean-side opening of the exchange or housing filter is connectable, is provided with the connecting channel which opens radially into the pump channel.

In particular, the connecting socket can be oriented vertically, like the exchange or housing filter.

According to a further embodiment, a branch channel connects the pump channel with the outlet channel. The branch channel can be arranged, for example, at a slant relative to a center axis of the pump channel or of the outlet channel in order to be able to produce it in a simple way.

According to a further embodiment, a bypass channel connects the connecting channel with the outlet channel wherein the second bypass valve has a valve seat which connects a vertical section of the bypass channel with the outlet channel.

A valve member, for example, in the form of a ball, can be seated in the valve seat. The second bypass valve, in particular the valve member, can be accessible by an oppositely provided maintenance opening in the tubular body which is forming the outlet channel. The maintenance opening can be formed in a vertical channel which is provided with a venting opening in its wall. Additionally or alternatively, the vertical channel can serve as a connector for a fuel line which connects the outlet channel with a main filter.

Moreover, a filter arrangement for an internal combustion engine with a filter head, as described above, and an exchange or housing filter is proposed.

Furthermore, a fuel system for an internal combustion engine with a filter head or a filter arrangement, as described above, and a control device is provided. The control device is adapted to control the pump alternatingly in at least two of the operating modes.

Moreover, a method for operating the afore described filter head, the afore described filter arrangement or the afore described fuel system is provided, wherein initially one of at least two of the operating modes of the pump is selected and the pump thereafter is operated in the selected operating mode.

The features described in connection with the filter head apply likewise to the filter arrangement, the fuel system, and the method, and vice versa.

In the present application, “a” does not preclude a multitude.

Further possible implementations of the invention comprise also combinations, not explicitly mentioned, of features explained above or in the following with regard to the embodiments. A person of skill in the art will also add or modify individual aspects as improvements or supplements to the respective basic form of the invention.

Further advantageous configurations and aspects of the invention are subject matter of the dependent claims as well as of the embodiments of the invention described in the following. In the following, the invention will be explained in more detail with the aid of embodiments with reference to the attached figures.

### BRIEF DESCRIPTION OF THE DRAWINGS

FIG. 1 is a perspective view a filter head with a screwed-on exchange filter according to an embodiment.

FIG. 2 shows the components of FIG. 1 in an exploded view.

FIG. 3 shows the filter head of FIG. 1 in enlarged illustration.

FIG. 4 shows the filter head of FIG. 3 in an exploded view as well as in mirror-symmetrical assembly arrangement.

FIG. 5 is a section V-V as indicated in FIG. 1.

FIG. 6 is a section VI-VI as indicated in FIG. 1.

FIG. 7 is a section VII-VII as indicated in FIG. 1.

FIG. 8 is a section VIII-VIII as indicated in FIG. 1.

FIG. 9 is a section IX-IX as indicated in FIG. 1.

FIG. 10 shows a fuel system with the arrangement of FIG. 1 in a first operating state.

FIG. 11 shows the fuel system of FIG. 10 in a second operating state.

FIG. 12 shows the fuel system of FIG. 10 in a third operating state.

FIG. 13 is an exploded view of a filter head with a housing filter according to an embodiment.

FIG. 14 is a section XIV-XIV as indicated in FIG. 13.

In the Figures, same reference characters identify same, or functionally the same, components inasmuch as nothing to the contrary is indicated.

### DESCRIPTION OF PREFERRED EMBODIMENTS

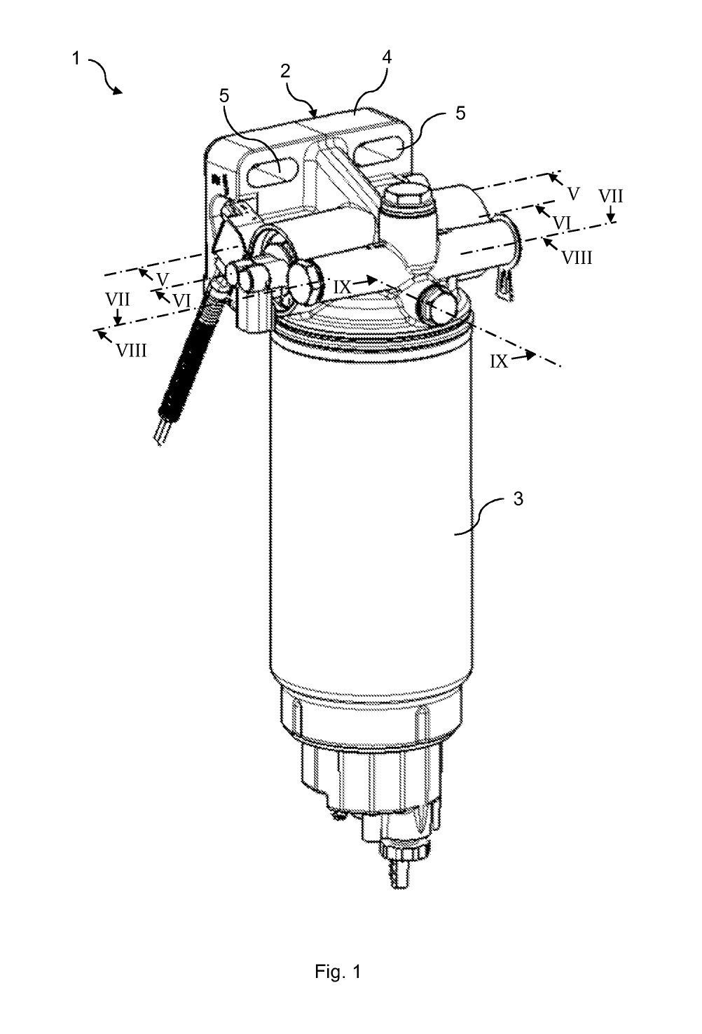

FIG. 1 shows a filter arrangement 1 with a filter head 2 and an exchange filter 3, also referred to as spin-on filter, screwed onto the filter head 2.

The filter head 2 comprises a base plate 4 with bores 5 for attachment of the filter head 2 on a vehicle frame or an engine block.

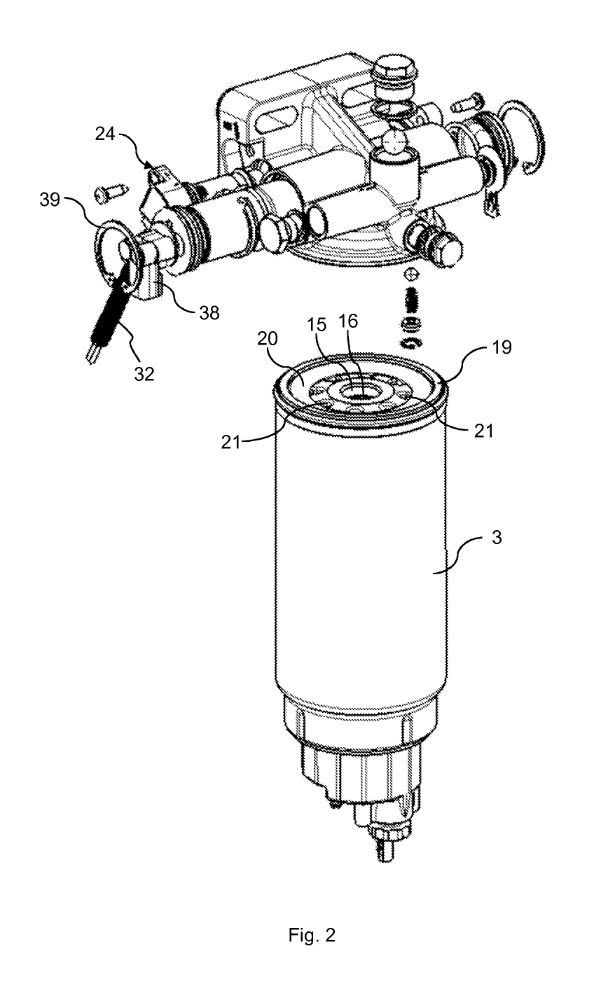

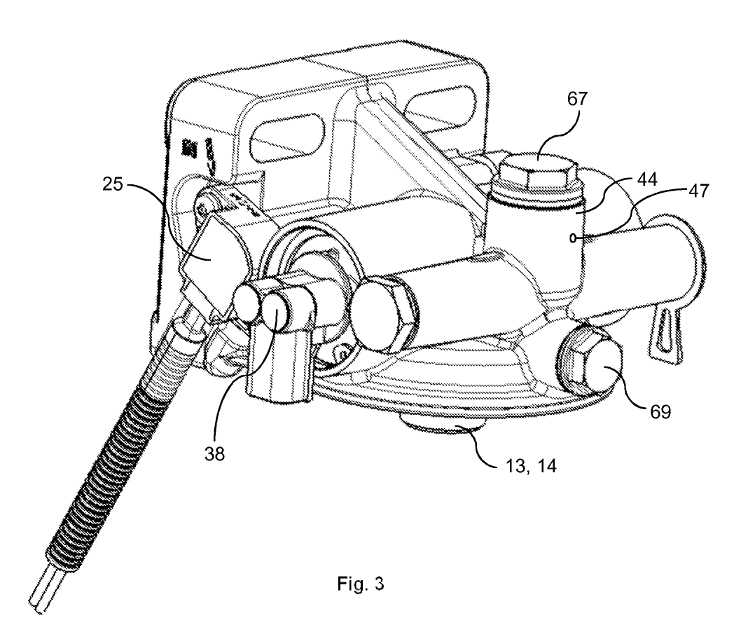

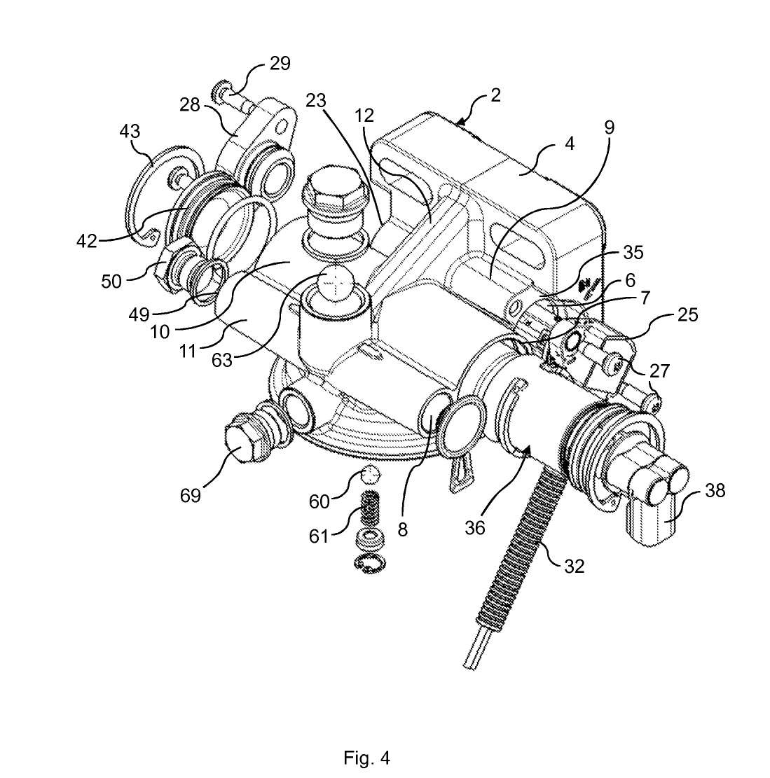

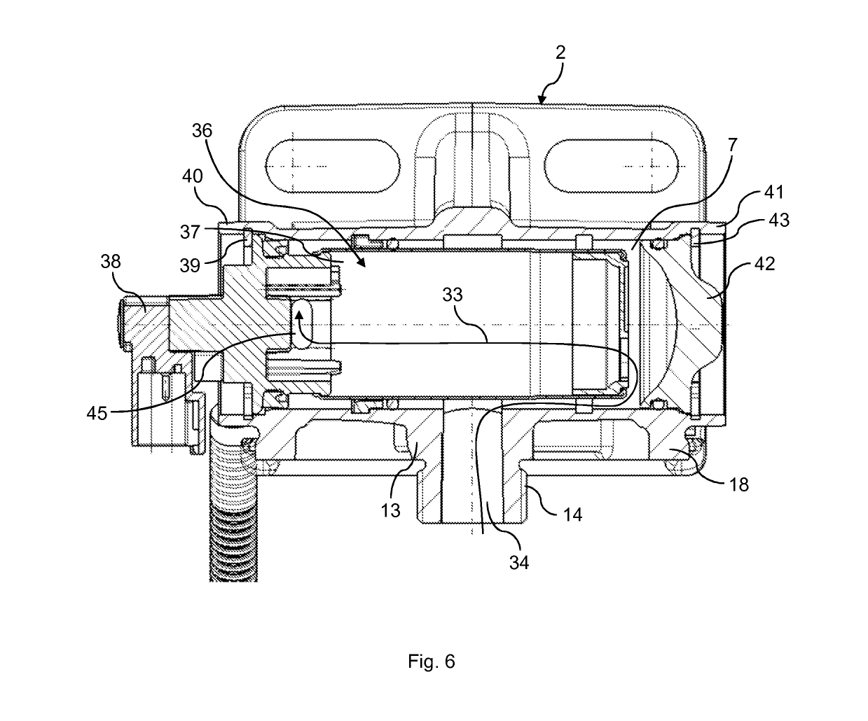

As can be seen in FIG. 4, the filter head 2 comprises three parallel channels 6, 7, 8, wherein 6 indicates an inlet channel, 7 indicates a pump channel, and 8 indicates an outlet channel. The channels 6, 7, 8 can be formed each in a tubular body 9, 10, 11 which are connected to each other by a web 12 and connected with the base plate 4. In downward direction, the filter head 2 comprises a connecting socket 13 that can be seen in FIGS. 3 and 6 and has at its lower end an outer thread 14. An inner thread 15 of the exchange filter 3, indicated in FIG. 2, can be screwed onto the outer thread 14. The inner thread 15 delimits a clean-side outlet opening 16 of the exchange filter 3.

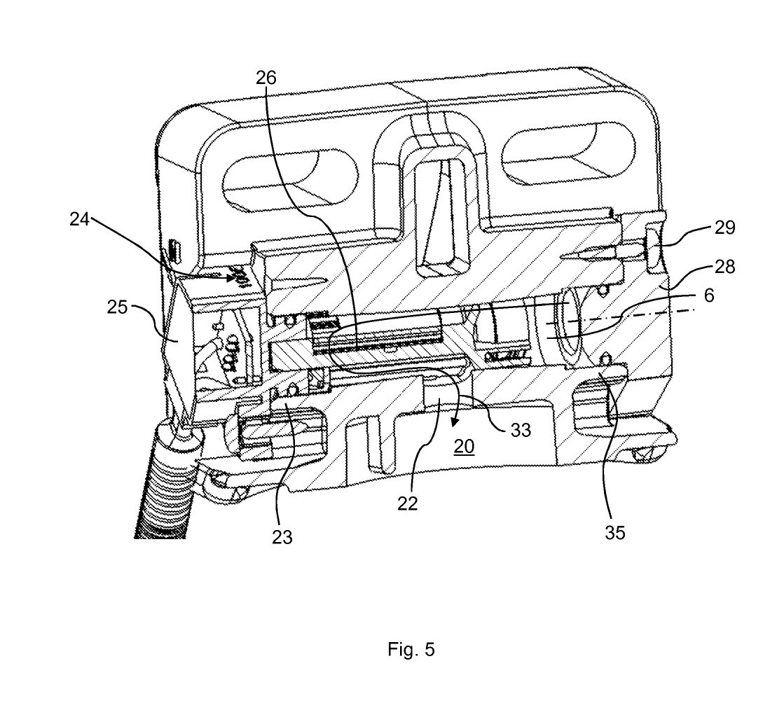

Returning to FIG. 6, there can be seen that the filter head 2 has an annular flange 18. In the screwed-on state, the circular ring-shaped flange 18 seals relative to a circular ring-shaped seal 19 of the exchange filter 2 that is illustrated in FIG. 2. Raw-side inlet openings 21 (FIG. 2) of the exchange filter 3 open into the thus formed chamber 20 (see FIG. 5). The inlet openings 21 are, for example, arranged on a circular line about the outlet opening 16.

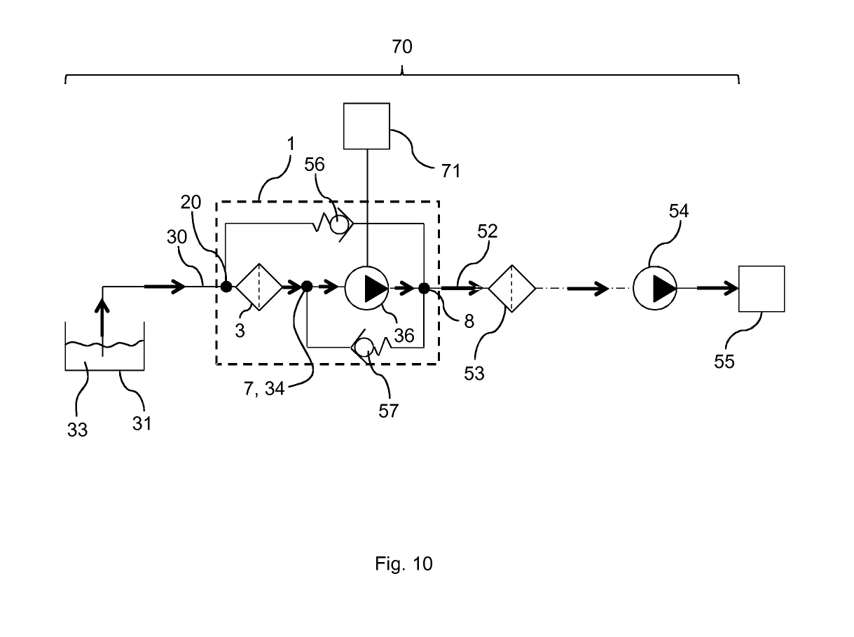

As shown in FIG. 5, the chamber 20 is connected by a channel 22, extending radially to the inlet channel 6, to the inlet channel 6. Also, FIG. 5 shows a heating device 24 for heating fuel which is flowing into the inlet channel 6. The heat prevents gelling (waxing) of the fuel. The heating device 24 can be an electrical attachment module 25 and can comprise a heating rod 26. The heating rod 26 extends in the mounted state from one end 23 of the inlet channel 6 into the inlet channel 6. The attachment module 25 is flange-connected to the tubular body 9 by means of screws 27 (see FIG. 4) and seals the end 23 of the inlet channel 6. At the other end 35 of the inlet channel 6, an adapter 28 can be flange-connected by means of screws 29. By means of the adapter 28, the inlet channel 6 can be connected with a fuel line 30 which is shown in FIG. 10. The fuel line 30 opens upstream into a tank 31.

With the aid of FIGS. 2 and 4 it can be seen that the heating device 24 can be installed from both ends 23, 35 into the inlet channel 6. In this way, it is possible to simply accommodate spatial conditions, in particular with regard to guiding a current connector 32 of the heating device 24.

Returning to FIG. 5, it is shown therein that the fuel 33, after having entered the inlet channel 6, flows through the heating rod 26 and then through the channel 22 into the chamber 20. From here, the fuel 33 flows through the inlet openings 21 (see FIG. 2) and then through a filter medium, not shown, of the exchange filter 3.

By means of the filter medium, for example, particles with a grain size >10 μm are separated from the fuel 33. Alternatively or additionally, by means of the filter medium water can be separated in the exchange filter 3. When the exchange filter 3 is spent, it can be separated from the filter head 2 by unscrewing it and can be exchanged.

After having passed through the filter medium, the pre-filtered fuel 33 passes from the outlet opening 16 (see FIG. 2) into a connecting channel 34 which is formed in the connecting socket 13, as shown in FIG. 6. It is, for example, vertically oriented and opens perpendicularly into the pump channel 7.

A pump 36 is arranged in the pump channel 7. The pump 36 comprises a brushless direct current motor 37 which drives a pump wheel, not illustrated. Moreover, the pump 36 comprises an electrical connecting module 38. The connecting module 38 is seal-tightly attached by means of a securing ring 39 at an end 40 of the pump channel 7, as shown in FIG. 6. The other end 41 of the pump channel 7 is seal-tightly closed off by a cap 42 which is secured in its position by a securing ring 43.

With the aid of FIGS. 2 and 4, it can be seen that also the pump 36 can be installed from both ends 40, 41 into the pump channel 7 so that also in this regard spatial considerations can be accommodated.

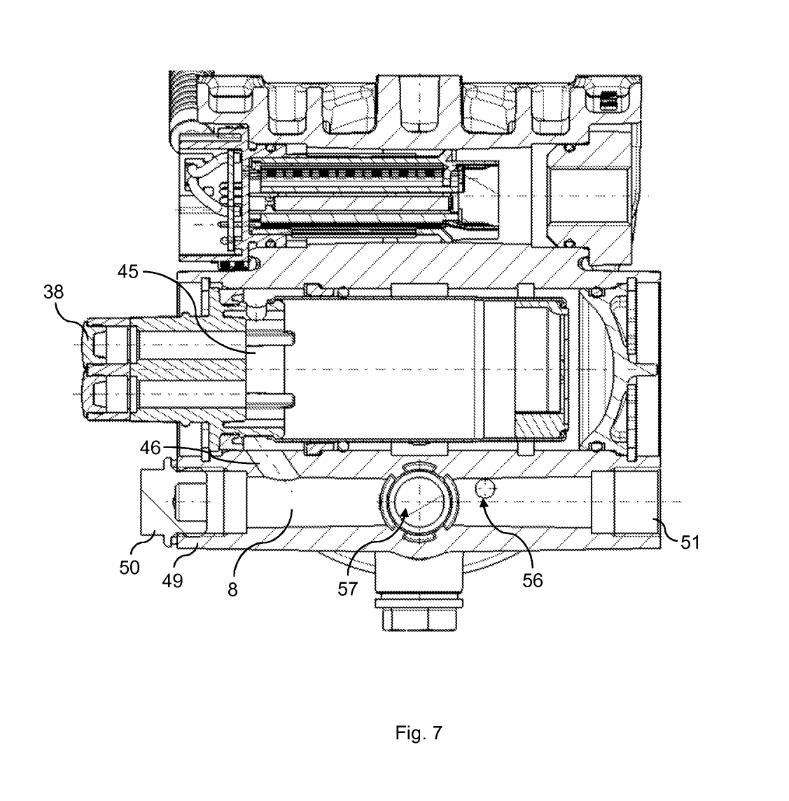

Starting from the connecting channel 34, the fuel 33 flows, as shown in FIG. 6, radially into the pump channel 7, thereafter along the pump channel 7, then through the pump 36 in reverse direction and by means of a radial outlet opening 45 out of it back into the pump channel 7 and from there through a branch channel 46, shown in FIG. 7, into the outlet channel 8. The branch channel 46 is slanted, i.e., is arranged at an angle different from 90° degrees relative to the outlet channel 8.

The outlet channel 8 is closed off seal-tightly at its end 49 by a screwed-in cap 50. The other end 51 of the outlet channel 8 is connected by means of a fuel line 52 illustrated in FIG. 10 with a main filter 53. The main filter 53 is connected in turn to a high pressure pump 54. The high-pressure pump 54 supplies the fuel to an injection device, not illustrated, of an internal combustion engine 55.

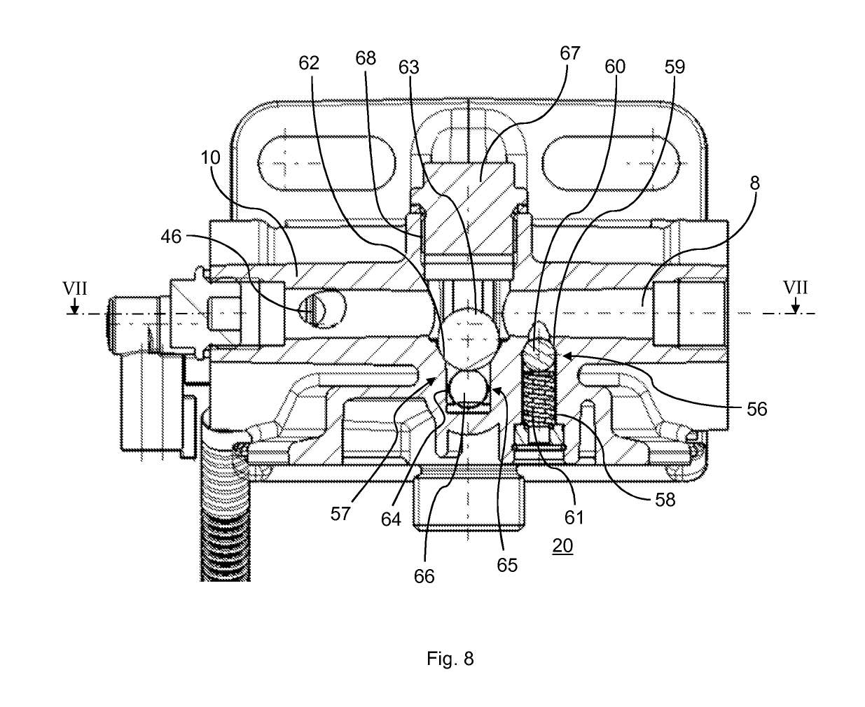

Returning to FIG. 7, a first bypass valve 56 and a second bypass valve 57 are shown therein. The bypass valves 56, 57 can also be seen in FIG. 8.

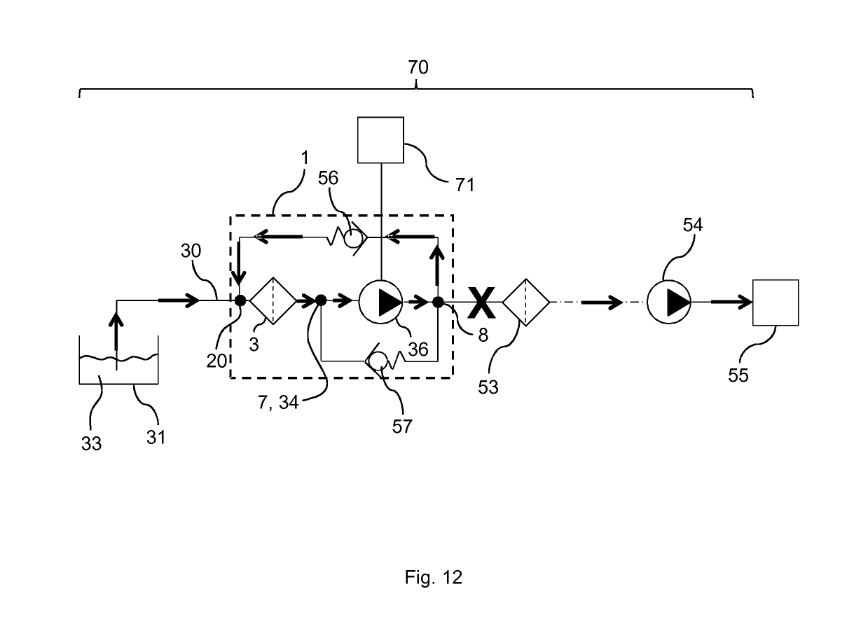

The first bypass valve 56 comprises a branch channel 58 which connects the outlet channel 8 with the chamber 20. In the branch channel 58 a valve seat 59 is formed against which, in the closed state of the first bypass valve 56 shown in FIG. 8, a spherical valve member 60 is resting seal-tightly. The valve member 60 is biased by means of a spiral spring 61 arranged in the branch channel 58 against the valve seat 59. The first bypass valve 56 opens only at the time when the pressure in the outlet channel 8 has surpassed a predetermined pressure, for example, 5 bar. This is typically the case when the main filter 53 (see FIG. 10) is clogged. Here, the branch channel 58 forms a bypass channel. The return flow through the first bypass valve 56 is illustrated in FIG. 12.

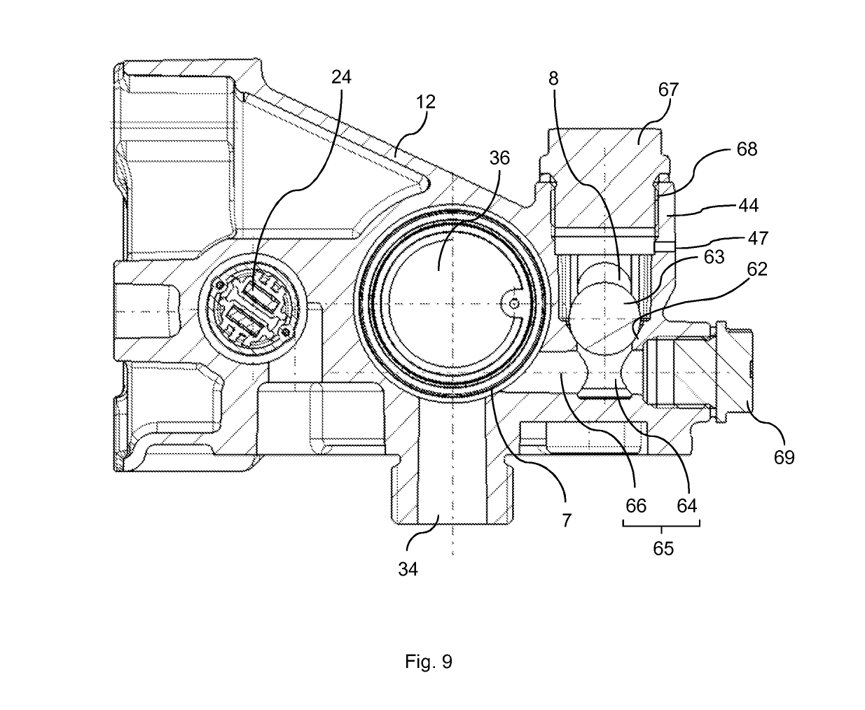

The second bypass valve 57 comprises a valve seat 62 which is closed off by a spherical valve member 63. Here, the closure force is generated by gravity that is acting on the valve member 63. The valve seat 62 is formed at the end of a vertical section 64 of a bypass channel 65 and opens into the outlet channel 8. The bypass channel 65 has moreover a horizontal section 66 which, as shown in FIG. 9, connects the vertical section 64 with the connecting channel 34 that is correlated with the clean side of the exchange filter 3.

Furthermore, in FIG. 9 in combination with FIG. 8, a cap 67 is to be seen which is screwed into a maintenance opening 68 opposite the valve member 63. The maintenance opening 68 is formed in a maintenance channel 44 which is oriented perpendicular to the outlet channel 8 and upward. A venting opening 47 can be formed below the cap 67 in the wall of the maintenance channel 44.

In an embodiment, the fuel line 52 can be connected also to the maintenance channel 44.

In FIG. 9, a cap 69 is moreover illustrated which is screwed seal-tightly into the horizontal section 66 of the bypass passage 65.

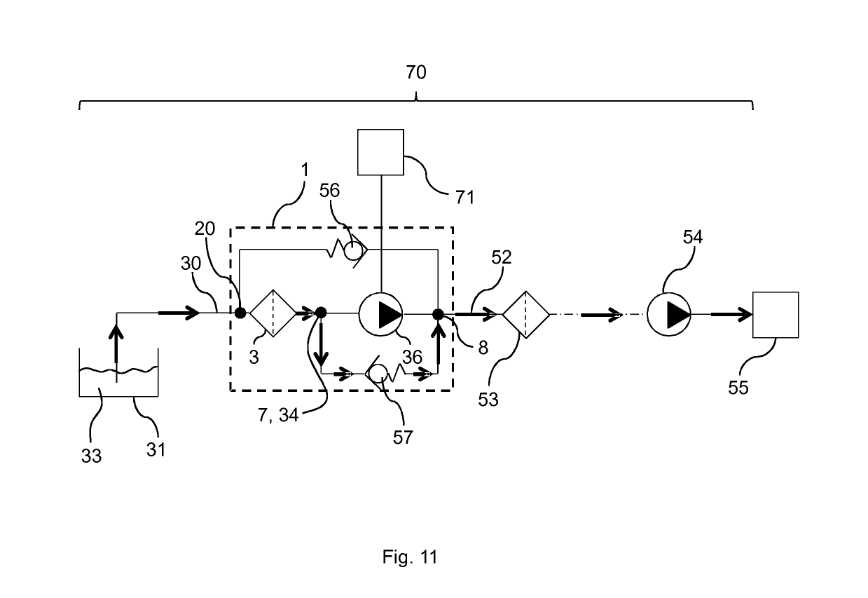

When the high-pressure pump 54 is sucking, with the pump 63 switched off, it generates underpressure in the outlet channel 8. When this underpressure drops below a predetermined value, for example, 30 mbar, the valve member 63 moves upwardly so that the second bypass valve 57 opens. Accordingly, fuel 33 can flow directly, bypassing the pump 36, from the clean side of the exchange filter 3 through the connecting channel 34 illustrated in FIG. 9 and the bypass channel 65 to the outlet channel 8, as illustrated in FIG. 11.

In addition to the already disclosed components, the fuel system 70 shown in FIG. 10 comprises a control device 71 which is adapted to control the pump 36, in particular the direct current motor 37, in three different operating modes. The first operating mode is a feed or follow-up operation in which the pump 36, before switching on or after switching off an ignition of the internal combustion engine 55, supplies the fuel to the outlet of the outlet channel 8. The second operating mode is a venting operation in which the pump 36 pumps air out of the exchange filter 3 as well as out of the fuel lines 30, 52. The control device 71 switches the pump 36 in particular automatically into the venting operation when the control device 71 determines that the exchange filter 3 has been exchanged. Alternatively, the control device 71 can be switched to venting operation by means of a user input, for example, by pressing on a button. The third operating mode is a support operation in which the pump 36, with switched-on ignition of the internal combustion engine 55, supplies the fuel for the high-pressure pump 54 at a pressure that is suitable as an input pressure.

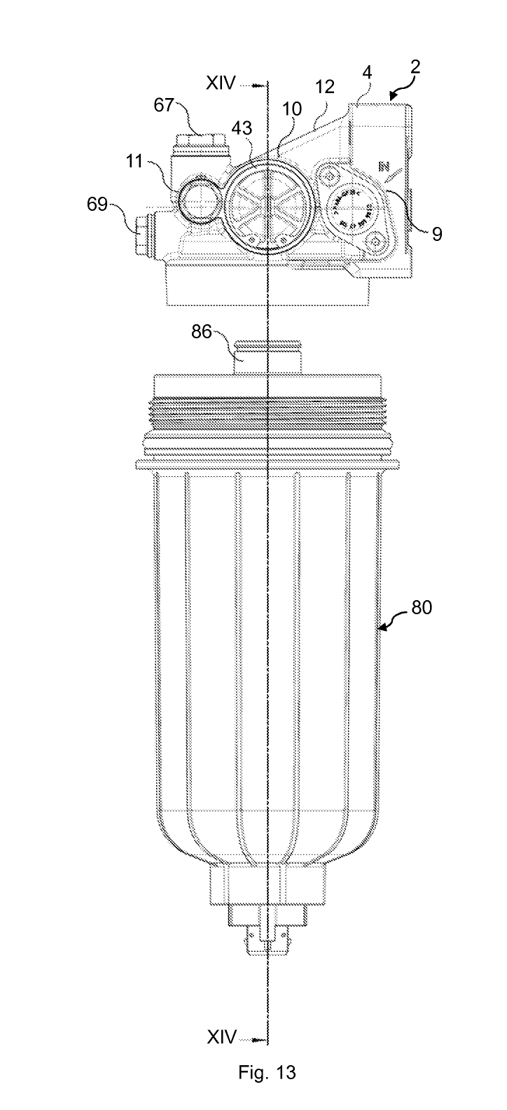

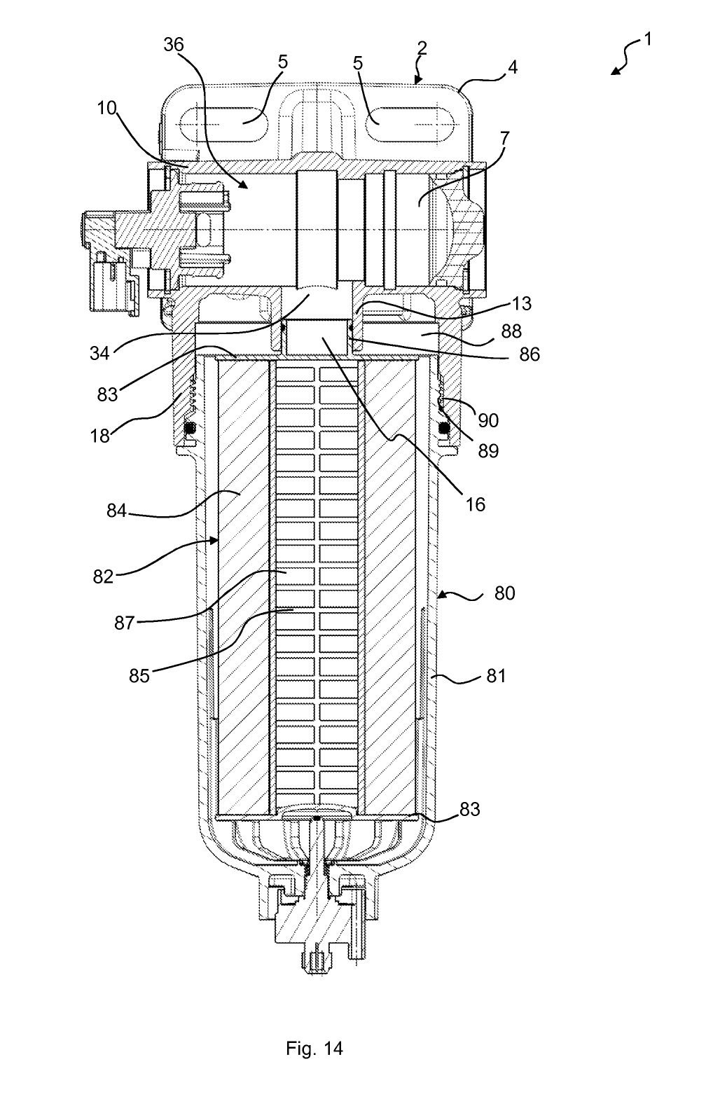

FIGS. 13 and 14 show a filter head 2 with a housing filter 80 according to an embodiment.

The housing filter 80 comprises a cup-shaped housing 81 with a filter element 82 that is exchangeably provided therein. The filter element 82 has, for example, a filter medium 84 which is arranged between two end disks 83. The filter medium 84 has in particular a cylindrical configuration with a circular ring-shaped base surface. A support tube 85 extends centrally through an interior 87 of the filter medium 84. The filter element 82, in particular the upper end disk 83, has an outlet 86 which seal-tightly projects into the connecting channel 34 of the connecting socket 13 of the filter head 2. The outlet 86 is connected with the interior 87 and forms the clean side of the filter element 82. A space 88 which surrounds the filter medium 84 is in communication with the inlet channel 6 by means of the channel 22 illustrated in FIG. 5 and forms therefore the raw side of the filter element 82.

The housing 81 has at the upper end an outer thread 89 by means of which it is seal-tightly screwed into an inner thread 90 at the annular flange 18 of the filter head 2. The housing 81 and the flange 18 delimit the space 88 in outward direction. In the unscrewed state of the housing 81, the filter element 84 can be exchanged. By screwing the housing 81 into the filter head 2, the outlet 86 is pushed seal-tightly into the connecting socket 13. Accordingly, the thread 14 shown in FIG. 6 is not needed.

In other respects, the configuration and function correspond to the embodiment according to FIGS. 1 through 12.

Even though the present invention has been explained with the aid of various embodiments, it is not limited thereto but can be modified in many ways.

What is claimed is:

1. A filter head for an exchange or housing filter for pre-filtration of fuel for an internal combustion engine, the filter head comprising:
a pump channel;
an electrically operating pump received at least partially in the pump channel;
a connecting channel adapted to connect the pump at a suction side of the pump with a clean side of the exchange or housing filter;
an outlet channel adapted to connect the pump at a pressure side of the pump with a main filter for filtration of pre-filtered fuel;
the pump adapted to be alternatingly operated in at least two of the following operating modes:
a feed or follow-up operation in which, before switching on or after switching off an ignition of an internal combustion engine, the pump supplies fuel to the outlet channel,
a venting operation in which the pump pumps air out of the exchange or housing filter and/or out of a fuel line connected to the filter head, and
a support operation in which, with switched-on ignition of the internal combustion engine, the pump supplies fuel at a pressure that is suitable as an input pressure for a high-pressure pump that is arranged downstream of the main filter.

2. The filter head according to claim 1, further comprising a bypass valve connecting the pump at the pressure side of the pump with the clean side or a raw side of the exchange or housing filter when a pressure at the pressure side of the pump surpasses a predetermined pressure value.

3. The filter head according to claim 2, wherein the bypass valve is a check valve that is biased by a spring.

4. The filter head according to claim 1, further comprising a bypass valve connecting the clean side of the exchange or housing filter with the outlet channel when a pressure in the outlet channel drops below a predetermined pressure when the pump is switched off.

5. The filter head according to claim 4, wherein the bypass valve is embodied as a gravity-loaded check valve.

6. The filter head according to claim 4, wherein the bypass valve has a spherical valve member.

7. The filter head according to claim 4, further comprising a bypass channel that connects the connecting channel with the outlet channel, wherein the bypass valve has a valve seat that connects a vertical section of the bypass channel with the outlet channel.

8. The filter head according to claim 1, wherein the pump channel has a first end and a second end, wherein the pump is attachable to the first end or the second end of the pump channel.

9. The filter head according to claim 1, further comprising an inlet channel and a heating element received at least partially in the inlet channel, wherein the inlet channel has a first end and a second end, wherein the heating element is attachable to the first end or the second end of the inlet channel.

10. The filter head according to claim 9, wherein the pump channel, the inlet channel, and the outlet channel are arranged parallel to each other.

11. The filter head according to claim 9, wherein at least one of the pump and of the outlet channel is arranged parallel to the inlet channel.

12. The filter head according to claim 1, wherein the pump channel and the outlet channel are arranged parallel to each other.

13. The filter head according to claim 1, further comprising a connecting socket that is connectable to a clean-side opening of the exchange or housing filter, wherein the connecting socket is provided with the connecting channel which radially opens into the pump channel.

14. The filter head according to claim 1, further comprising a branch channel that connects the pump channel with the outlet channel.

15. A fuel system for an internal combustion engine, comprising a filter head according to claim 1 and a control device adapted to control the pump of the filter head for alternatingly providing at least two of the operating modes of the pump of the filter head.

16. The fuel system according to claim 15, further comprising an exchange or housing filter connected to the filter head

17. A method for operating a filter head according to claim 1, the method comprising:
selecting one of at least two of the operating modes of the pump of the filter head and thereafter operating the pump in the selected operating mode.

18. A method for operating a fuel system according to claim 15, the method comprising:
selecting one of at least two of the operating modes of the pump of the filter head and thereafter operating the pump in the selected operating mode.

19. A filter head for an exchange or housing filter for pre-filtration of fuel for an internal combustion engine, the filter head comprising:
a pump channel;
an electrically operating pump received at least partially in the pump channel and having a suction side and a pressure side;
a connecting channel adapted to connect the suction side or the pressure side of the pump with a clean side of the exchange or housing filter;
an outlet channel adapted to connect the pressure side or the suction side of the pump with a main filter for filtration of pre-filtered fuel;
wherein the pump channel has a first end and a second end, wherein the pump is attachable to the first end or the second end of the pump channel.
